(19) United States
(12) Patent Application Publication
(10) Pub. No.: US 2026/0172519 A1
(43) Pub. Date: Jun. 18, 2026

(54) DOCUMENT SCANNER

(71) Applicant: DESKO GmbH, Bayreuth (DE)

(72) Inventor: Wojciech BUJAK, Pegnitz (DE)

(73) Assignee: DESKO GmbH, Bayreuth (DE)

(21) Appl. No.: 19/416,305

(22) Filed: Dec. 11, 2025

(30) Foreign Application Priority Data
Dec. 12, 2024 (DE) 10 2024 137 446.2

(51) Int. Cl. H04N 1/10; H04N 1/00

(52) U.S. Cl. CPC H04N 1/1065; H04N 1/00557

(57) ABSTRACT

A document scanner comprises a housing in which a document scanning device is arranged. The housing comprises a scanning aperture for a scanning area of the scanning device. The scanning aperture is surrounded by a receiving area of the housing for a transparent support plate. The support plate covers the scanning aperture and serves as a support for a document to be scanned. A polymer seal surrounding the scanning aperture is arranged between the support plate and the receiving area. The document scanner is dust-and splash-proof and is therefore suitable for outdoor use.

### CROSS-REFERENCE TO RELATED APPLICATIONS

This application claims the benefit of DE 10 2024 137 446.2, filed Dec. 12, 2024, the disclosure of which is hereby incorporated herein in its entirety by reference.

### BACKGROUND OF THE INVENTION

### Field of the Invention

The present invention relates to a document scanner, such as, for example, scanners used in security-relevant locations such as government offices or airports to record the identity of persons.

### Background

A document scanner typically comprises a housing in which a document scanning device, such as a laser scanner, is arranged. The housing also comprises a scanning aperture for the passage of a scanning area of the scanning device, whereby the scanning aperture is surrounded by a receiving area for a transparent support plate. The transparent support plate is designed to cover the scanning aperture and allow the scanning area to pass therethrough. The support plate also serves for holding or supporting a document to be scanned.

A document scanner of this type should also be usable outdoors, where it is exposed to the weather.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. It is an object of the present invention to further develop a document scanner of the above-mentioned type in such a way that it is suitable for outdoor use. Further advantageous aspects, details, and embodiments of the invention are apparent from the following detailed description of the embodiments and the accompanying drawings.

According to an embodiment of the invention, a polymer seal surrounding the scanning aperture is arranged between the support plate and the receiving area of the housing. This prevents dust or moisture from entering the interior of the housing through the scanning aperture and possibly impairing the scanning performance of the scanning device. The design of the document scanner according to the invention thus achieves full operational capability, such as, for example, in accordance with an Ingress Protection (IP) rating as defined by the International Electrotechnical Commission (IEC) under the international standard IEC 60529, such as, for example IP54, making it particularly suitable for outdoor use.

Preferably, the polymer seal is arranged in a groove located in the receiving area of the housing, whereby it is held in a defined position in the receiving area.

Preferably, the polymer seal protrudes slightly above the groove. The support plate then presses on the protruding area of the polymer seal, causing it to deform slightly and thereby creating a secure seal between the groove in the receiving area of the housing and the support plate.

Preferably, the scanning device is formed by a laser scanner, which has proven to be reliable and safe for document scanning. However, it is also possible to use other optical scanning devices that are common in the prior art.

In an advantageous further development of an embodiment of the invention, the polymer seal is designed as a closed sealing ring completely surrounding the scanning aperture. By designing the polymer seal as a closed sealing ring, there is no gap through which water can penetrate into the interior of the housing through the scanning aperture. In principle, it is possible to use an elongated polymer seal and fold it into a ring shape, but this poses the problem that the adjoining or overlapping ends of the polymer seal form a potential entry point for water or dirt. This is effectively avoided with a closed sealing ring.

In an advantageous further development of an embodiment of the invention, the polymer seal is a silicone rubber seal. A silicone rubber seal is highly deformable and also comprises a good sealing quality, making this type of material ideal for sealing between the support plate and the receiving area of the housing.

Preferably, the polymer seal comprises a Shore hardness between 40 and 70, which means that when the support plate is mounted on the receiving area of the housing, the polymer seal is soft enough to be deformed and thus, due to the spring force generated by deformation, to achieve a very good seal between the support plate and the receiving area of the housing.

In principle, it would be possible to use a polymer seal with any cross-section. However, the polymer seal is preferably designed as an O-ring seal, which has the advantage that incorrect or wedged installation, as is possible with polymer seals with a rectangular cross-sectional area, for example, is ruled out, so that the polymer seal is correctly positioned when arranged around the scanning aperture in the receiving area of the housing, in particular when arranged in a defined manner in a groove.

In an advantageous further development of an embodiment of the invention, the mounting plate is mounted on the housing in such a way that it presses on the polymer seal held in the mounting area of the housing and slightly deforms it, which, as already explained above, results in a pressing force of the polymer seal between the mounting plate and the receiving area of the housing, ensuring a reliable seal of this intermediate space.

An advantageous further development of an embodiment of the invention is designed in such a way that a first side edge of the support plate is received by a step-like edge receiving portion on the housing and is thereby fixed to the receiving area. This has the advantage that the support plate is secured against the receiving area by means of a positive fit when its first side edge is applied to the edge receiving portion, so that by fixing the second side edge of the support plate, which is facing away from the first side edge, secure mounting of the support plate on the receiving area is enabled, which also allows pressure to be exerted by the support plate on the polymer seal located underneath.

Preferably, the edge receiving portion is formed by a protruding step which protrudes at an acute angle, in particular at an angle between approximately 30 and approximately 60 degrees, preferably at an angle of approximately 45 degrees, from the receiving area, and the first side edge of the support plate is inclined at an equally acute angle to the plane of the support plate, so that when a support plate rests on the receiving area, the edge receiving portion and the first side edge of the support plate are aligned with each other. In this way, the edge receiving portion, in cooperation with the aligned first side edge of the support plate, presses the support plate against the receiving area and thus against the polymer seal, resulting in a good seal between the support plate and the housing. Alternatively, it is also possible to form a profile, e.g., a step, in the first side edge of the support plate, which is aligned with a corresponding profile of the edge receiving portion. This allows the support plate to be brought into a form-fit relationship with the edge receiving portion, in particular by means of a pivoting movement, whereby the support plate is then fixed at its first side edge against the receiving area of the housing.

In this case, the support plate is preferably fixed on its second side edge facing away from the first side edge to the receiving area of the housing by a document attachment element. This document attachment element then presses the support plate down onto the receiving area at its second side edge and secures it to the housing, whereby the polymer seal underneath is also firmly fitted between the support plate and the receiving area of the housing. The document attachment element can be secured to the housing, for example, with screws or in any other known manner. For this purpose, the document attachment element comprises a pressing area that extends over the support plate and presses the support plate against the receiving area of the housing.

The receiving area of the housing is preferably set back slightly from the surface at the upper side of the housing, in particular by approximately the thickness of the support plate, with the result that the surface of the support plate is flush with the surface of the housing at its upper side. This also counteracts the ingress of dirt and facilitates cleaning of the document scanner.

### BRIEF DESCRIPTION OF THE DRAWINGS

Embodiments of the invention are described below with reference to the attached schematic drawings, which show:

FIG. 1, a schematic side view of an embodiment of a document scanner, with separately shown support plate, polymer seal and document attachment element,

FIG. 2, a side view of the document scanner of FIG. 1, in its fully assembled state,

FIG. 3, an enlarged view of detail III from FIG. 1,

FIG. 4, an enlarged view of detail IV from FIG. 2, and

FIG. 5, a plan view V of the assembled document scanner of FIG. 2.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined by the appended claims, along with the full scope of the equivalents to which such claims are entitled.

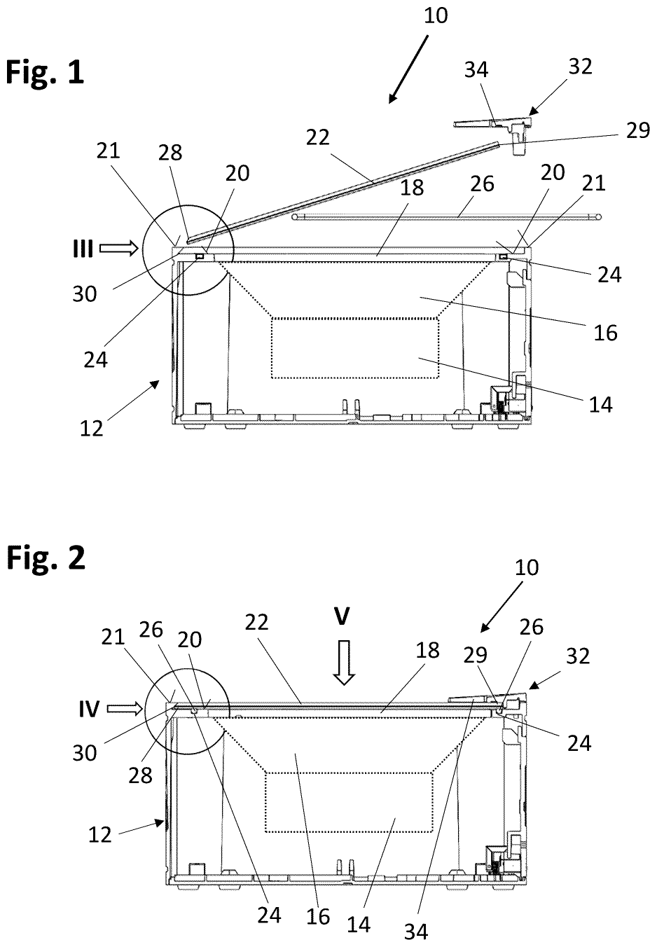

FIG. 1 shows a document scanner 10 with a cuboid housing 12, which encloses a scanning device 14 shown schematically. The scanning device 14 comprises a scanning area 16 directed upward toward a scanning aperture 18 in the housing 12. A receiving area 20, which is set back from a surface 21 on the upper side of the housing, surrounds the scanning aperture 18. The receiving area 20 is designed to receive a transparent support plate 22, in particular made of glass.

A groove 24 surrounding the scanning aperture 18 is arranged in the receiving area 20, which is designed to accommodate a closed polymer seal, in particular a polymer ring seal 26. The ring seal 26 is made of a soft polymer, in particular silicone rubber, and, as shown in the figure, is designed as an O-ring seal.

The offset of the receiving area 20 relative to the surface 21 is slightly greater than the thickness of the support plate 22, so that the support plate 22 inserted into the receiving area 20, which is pushed slightly away from the surface of the receiving area 20 by the polymer seal 26, is flush with the surface 21 of the housing 12.

FIG. 1 shows an exploded view with the separate polymer seal 26 and support plate 22. The support plate 22 is shown in FIG. 1 in a state of being inserted into the receiving area 20 of the housing 12. The support plate 22 comprises a first side edge 28 that runs at an acute angle to the lower surface of the support plate 22. An edge receiving portion 30 is formed on the housing 12 adjacent to the receiving area 20, which is designed as a step arranged at an acute angle to the receiving area 20 of the housing. The support plate 22 is inserted into this acute-angled edge receiving portion 30 with its first side edge 28, which is also acute-angled. The polymer ring seal 26 is inserted into the groove 24 between the support plate 22 and the receiving area 20 of the housing 12, wherein an upper side of the polymer ring seal 26 protrudes slightly from the groove 24. After inserting the first side edge 28 into the edge receiving portion 30 of the housing 12, the support plate is pressed down onto the receiving area 20 and secured by a document attachment element 32, which is mounted on the housing 12, in particular screwed to the housing. The document attachment element 32 comprises a pressing area 34 that extends over the support plate and presses the support plate 22 onto the receiving area 20 when the document attachment element 32 is mounted, securing it there.

Once assembly is complete, the document scanner 10 shown in FIG. 2 is obtained with the support plate 22 mounted and the polymer ring seal 26 arranged between the receiving area 20 and the support plate 22. Such an arrangement is well protected against dust and moisture and is therefore also suitable for outdoor use. It meets the requirements of an ingress protection class, such as IP54, and can therefore be considered reliable for outdoor use.

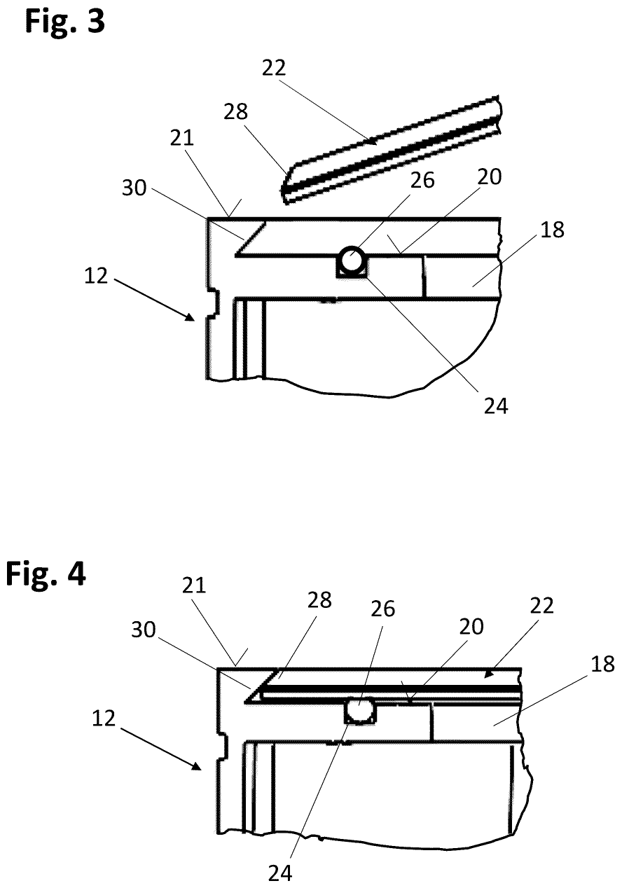

FIG. 3 shows detail III from FIG. 1, which shows an enlarged view of the first side edge 28 of the support plate 22 during insertion into the edge receiving portion 30 of the housing 12. The figure also illustrates how the O-ring seal 26 protrudes slightly upward from its groove 24 into the receiving area 20. This causes, as shown in FIG. 4 as detail IV from FIG. 2, the ring seal 26 to be slightly compressed and deformed by the support plate 22 after it has been mounted, whereby a compressive force is exerted by the support plate 22 and the groove 24 against the deformed polymer seal 26, resulting in a continuous seal. This effectively protects the scanning aperture 18 against the ingress of dust and splash water. FIG. 4 also shows clearly how the support plate 22 is fixed at its first side edge 28 by the edge receiving portion 30 of the receiving area 20 of the housing, which runs at an acute angle to the receiving area and thus engages the support plate 22 in a form-fitting manner against the receiving area 20.

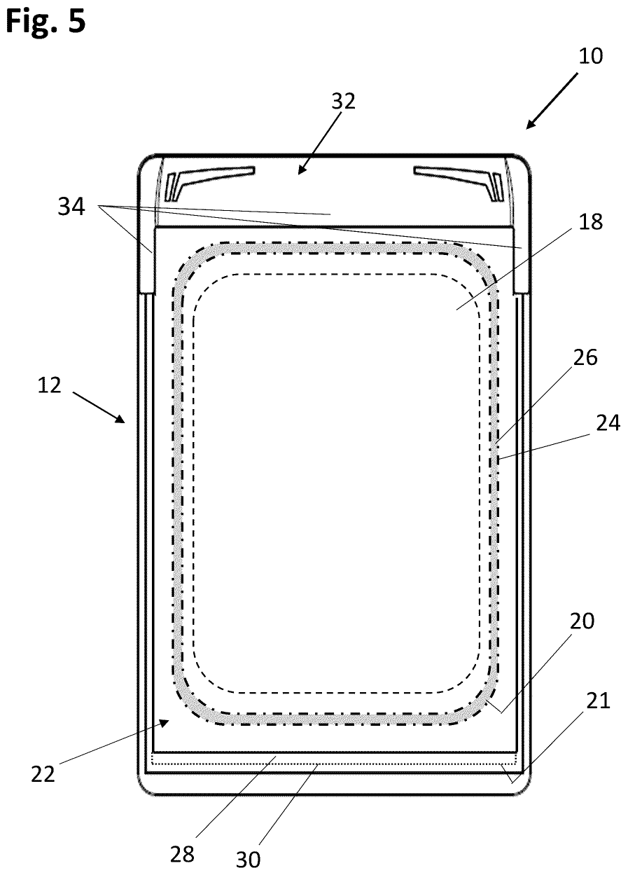

FIG. 5 shows plan view V of FIG. 2. This clearly shows the scanning aperture 18, the receiving area 20 surrounding the scanning aperture 18, the groove 24 arranged in the receiving area 20, and the closed ring seal 26 received therein, which is pressed against the receiving area by the support plate 22. At its first side edge 28, the support plate 22 is pressed by the edge receiving portion 30 onto the receiving area 20 and thus onto the ring seal 26. At its second side edge 29 (shown in FIGS. 1 and 2), the support plate 22 is gripped by the document attachment element 32 and thus pressed firmly against the receiving area 20, so that the support plate 22 is securely mounted against the receiving area 20 of the housing 12. The document attachment element 32 also serves to attach documents to be scanned there, so that the information to be scanned is arranged at a defined position in the scanning aperture and is thus reliably scanned by the scanning device 14 through the scanning aperture 18 and the transparent support plate 22.

The invention is not limited to the embodiment shown, but may instead be varied within the scope of the accompanying claims. Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

### LIST OF REFERENCE SIGNS

10 Document scanner
12 Housing of the document scanner
14 Scanning device (shown schematically only), in particular laser scanner
16 Scanning area of the scanning device
18 Scanning aperture in the housing
20 Receiving area for the support plate set back from the surface of the housing
21 Surface of the housing on its upper side
22 Transparent support plate, in particular made of glass, for covering the scanning aperture and for placing or positioning documents to be scanned.
24 Groove surrounding the scanning aperture in the receiving area of the housing
26 Ring-shaped closed O-ring seal arranged in the groove
28 First side edge of the support plate inclined at an acute angle toward the underside of the support plate
29 Second side edge of the support plate facing away from the first side edge
30 edge receiving portion for the first side edge of the support plate, inclined at an acute angle to the receiving area
32 Document attachment element for securing the second side edge of the support plate to the receiving area
34 Pressing area of the document attachment element for securing the support plate to the receiving area

What is claimed is:

1. A document scanner comprising a housing in which a document scanning device is arranged, said housing comprising a scanning aperture for a scanning area of the scanning device, wherein the scanning aperture is surrounded by a receiving area of the housing for a transparent support plate, wherein the support plate covers the scanning aperture and serves for placing or supporting a document to be scanned, and a polymer seal surrounding the scanning aperture arranged between the support plate and the receiving area of the housing.

2. The document scanner according to claim 1, wherein the polymer seal is arranged in a groove which is arranged in the receiving area of the housing.

3. The document scanner according to claim 2, wherein the polymer seal protrudes slightly upward above the groove.

4. The document scanner according to claim 1, wherein the scanning device is formed by a laser scanner.

5. The document scanner according to claim 1, wherein the polymer seal is designed as a closed sealing ring completely surrounding the scanning aperture.

6. The document scanner according to claim 1, wherein the polymer seal is a silicone rubber (VMQ) seal.

7. The document scanner according to claim 1, wherein the polymer seal comprises a Shore hardness between 40 and 70.

8. The document scanner according to claim 1, wherein the polymer seal is designed as an O-ring seal.

9. The document scanner according to claim 1, wherein the support plate is mounted on the housing in such a way that it presses on the polymer seal held in the receiving area thereby deforming it.

10. The document scanner according to claim 1, wherein a first side edge of the support plate is received by a step-like edge receiving portion on the housing and fixed to the receiving area.

11. The document scanner according to claim 10, wherein the edge receiving portion is formed by a step projecting from the receiving area at an acute angle, and the first side edge is inclined toward an underside of the support plate at an equally acute angle, so that when the support plate rests on the receiving area, the edge receiving portion and the first side edge of the support plate are aligned with each other.

12. The document scanner according to claim 11, wherein the angle is between approximately 30 and approximately 60 degrees.

13. The document scanner according to claim 11, wherein the angle is approximately 45 degrees.

14. The document scanner according to claim 10, wherein the support plate is fixed to the receiving area of the housing at its second side edge facing away from the first side edge by means of a document attachment element.

15. The document scanner according to claim 14, wherein the document attachment element comprises a pressing area for the support plate which extends over the support plate and presses the support plate against the receiving area at least at its second side edge.

16. The document scanner according to claim 1, wherein the receiving area is set back relative to a surface of an upper side of the housing by approximately a thickness of the support plate.
